(19) United States
(12) Patent Application Publication
(10) Pub. No.: US 2018/0346317 A1
(43) Pub. Date: Dec. 6, 2018

(54) WORK STATION OF A SYSTEM FOR PACKAGING PILLOWS

(71) Applicant: BRIGHI TECNOLOGIE ITALIA S.N.C. DI GABRIELE BRIGHI & C., Forlì, FC (IT)

(72) Inventor: Gabriele BRIGHI, Forlì (IT)

(21) Appl. No.: 15/571,236

(22) PCT Filed: May 4, 2016
(86) PCT No.: PCT/IT2016/000115

§ 371 Date: Nov. 1, 2017

(30) Foreign Application Priority Data
May 5, 2015 (IT) 102015902347953

(51) Int. Cl. B68G 7/06; B68G 7/05

(52) U.S. Cl. CPC B68G 7/06; B68G 7/051

(57) ABSTRACT

Described is a work station of a system for packaging pillows of the type comprising a magazine for stacked covers, a unit for transferring one single cover at a time on an operating line and a sewing machine. The work station comprises at least two tensioning lines, slidable parallel to the movement of the operating line for the entry of their free ends inside the cover and translatable transversely to the movement of the operating line for keeping the cover in the open configuration. At least one rotatable gripper, for clamping the end flap of the cover and its folding on the cover, defines an end turn-up. The work station also comprises an apparatus for inserting padding inside the cover.

This invention relates to a work station of a system for packaging pillows.

For making pillows and other padded objects (for example, products to be used in the furnishing sector, the automotive sector and even for toys) use is made of a series of consecutive operations normally performed by mutually independent machines.

Each station contains one or more operators, and performs an operation of the production cycle.

The production process for creating the pillow generally consists of the following main steps: bagging, during which the padding of the pillow is inserted in the cover, the cover generally having the desired shape of the pillow with 3 sides closed (sewn) and one open; bagging is performed on the open side; sewing, during which the open side of the cover is closed, completing the pillow; checking and arranging the pillow, during which the content of the pillow is made uniform throughout its volume and the most critical points of the pillow such as corners and sewing are checked; packaging which comprises the insertion of one or more pillows in a packaging bag; closing the bag by heat sealing the bag and pressing (to reduce the overall size) or with specific zips; boxing, packing and palletising the pillows.

Each of these steps is performed by a work station at least partly automated.

The bagging and sewing steps can be partly automated only in some specific cases.

More specifically, it should be noted that there is generally automatic bagging in the cases in which the material making up the padding consists of a single piece.

When the padding material consists of a plurality of single separate elements (small sized objects made of elastically deformable material which are soft to touch, such as objects made from expanded polymers or feathers or wool or other fibres and the like) the presence of an operator is normally necessary for checking and direct assistance in filling the cover.

This therefore results in an increase in production costs if pillows must be produced which are padded with small separate elements, since it is necessary to provide for the constant presence of an operator.

The sewing step may be easily automated if it is planned to carry out sewing with a machine of the so-called “cut and sew” type since this allows the flaps of the cover to be coupled (by sewing) eliminating the portion of the flap which protrudes with respect to the sewing.

However, this type of sewing has numerous drawbacks, since it generates waste (the portions of fabric eliminated from the “cut and sew”), adopts a plurality of threads (resulting in a non-optimum appearance) and it is considered by the end user to have a low quality level (or, in any case, medium-low).

The highest quality type of sewing comprises the turning up of a flap of the cover, towards the inside, and the subsequent sewing of the edge of the cover turned up in this way.

The result of this sewing is more attractive and longer lasting than that obtained by means of a machine of the so-called “cut and sew” type: however the operations comprise the intervention of an operator for forming the turn-up, making the surfaces match correctly and forwarding this turned up portion to the machine for sewing.

Consequently, this finishing is much more costly than that achieved with “cut and sew” machines due to the mandatory requirement for an operator to be present.

The main aim of this invention is to overcome the above-mentioned problems by providing a work station of a system for automated packaging.

As part of this task, an aim of the invention is to provide a work station of a system for packaging pillows which is able to package pillows with a high quality standard.

Another aim of this invention is to provide a work station of a system for packaging pillows comprising a closure sewing without waste and having upturned edges.

A further aim of this invention is to provide a work station of a system for packaging pillows which has low costs, is relatively simple to make and is safe to apply.

This task and these aims are achieved by a work station of a system for packaging pillows of the type comprising a magazine for stacked covers, a unit for transferring one single cover at a time on an operating line and a sewing machine, characterised in that it comprises at least two tensioning lines, slidable parallel to the movement of said operating line for the entry of their free ends inside said cover and translatable transversely to the movement of said operating line for keeping the cover in the open configuration, at least one rotatable gripper for clamping the end flap of said cover and its folding on the cover defining an end turn-up, and at least one apparatus for inserting a padding inside said cover.

Further features and advantages of the invention will emerge more fully from the description of a preferred but not exclusive embodiment of the work station of a system for packaging pillows according to the invention, illustrated by way of non-limiting example in the accompanying drawings, in which:

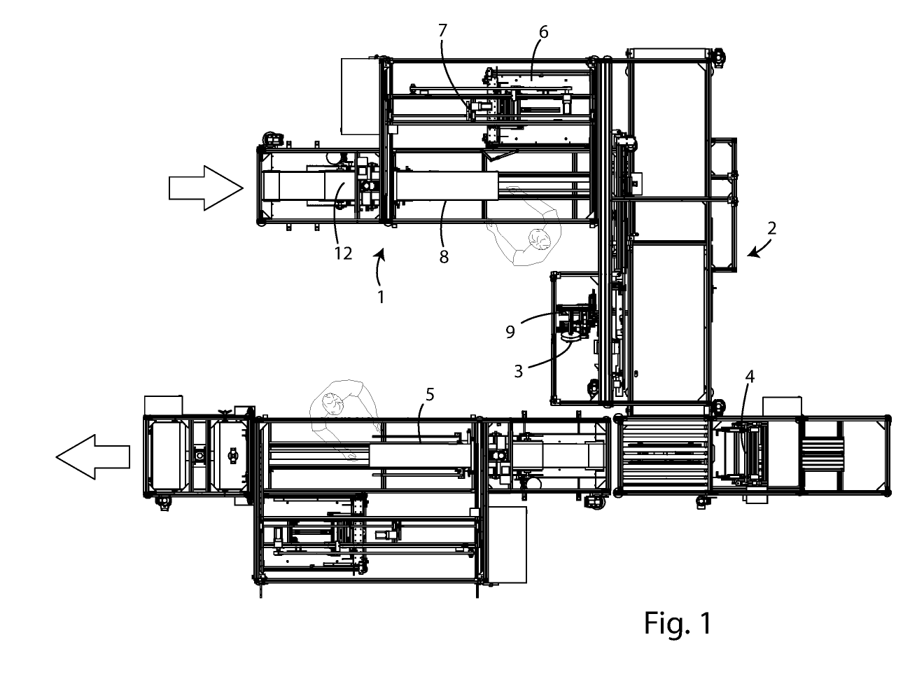

FIG. 1 shows a schematic view from above of a system for packaging pillows equipped with a work station according to the invention;

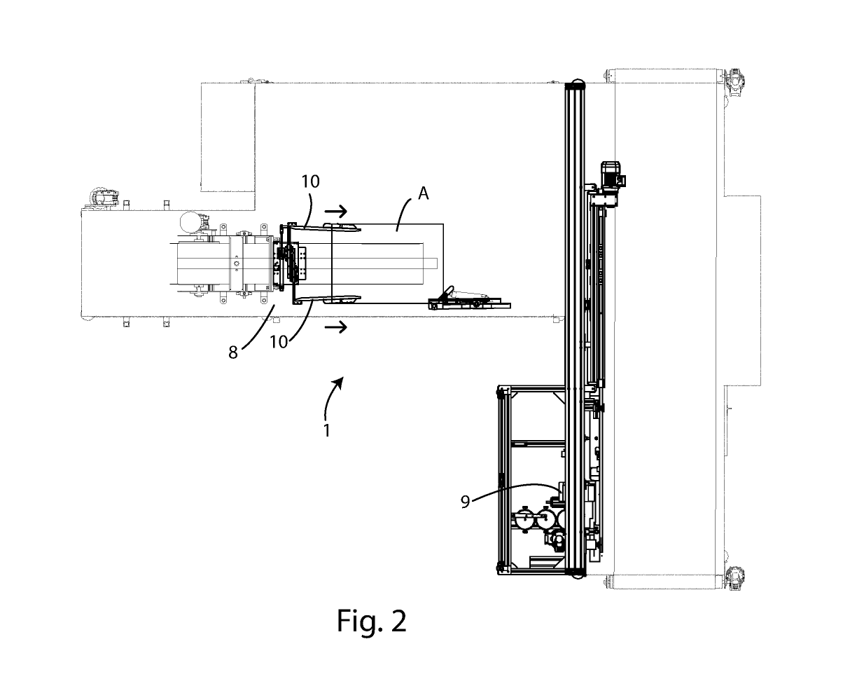

FIG. 2 shows a schematic view from above of a first configuration of a work station according to the invention;

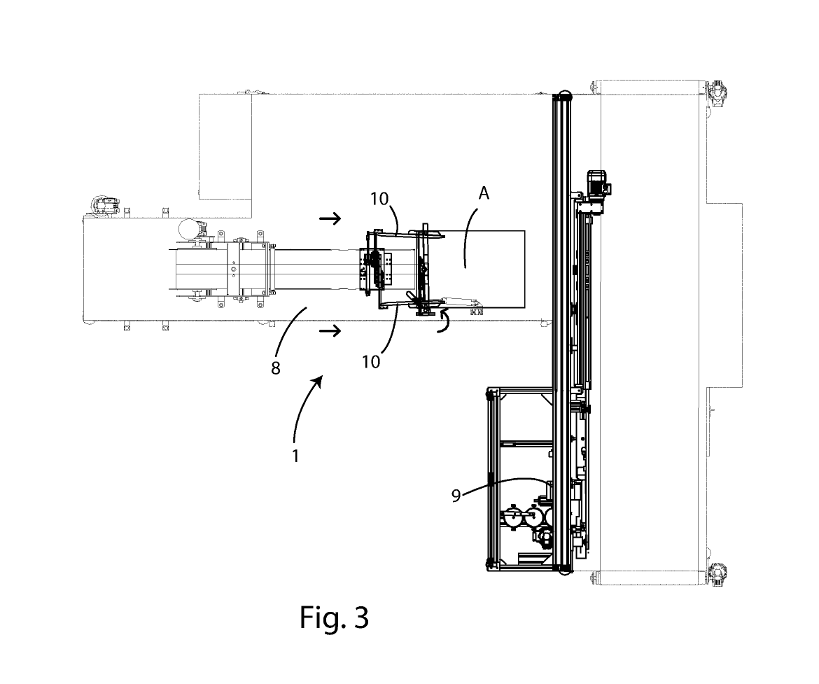

FIG. 3 shows a schematic view from above of a second configuration of the work station of FIG. 2;

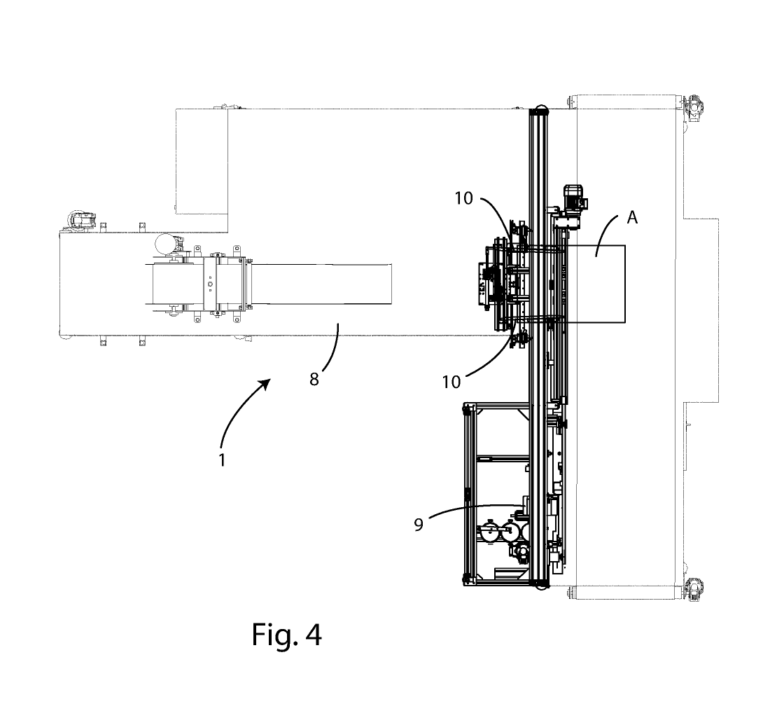

FIG. 4 shows a schematic view from above of a third configuration of the work station of FIG. 2;

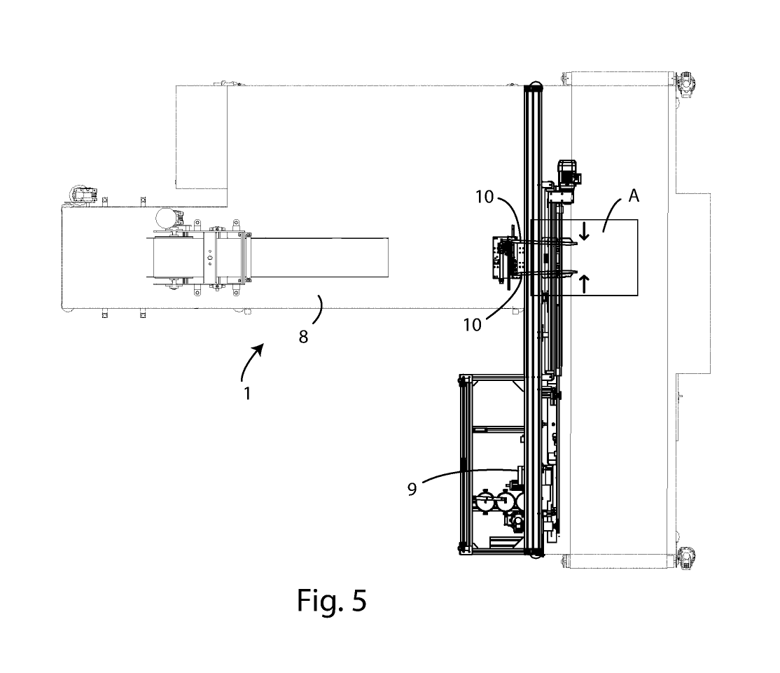

FIG. 5 shows a schematic view from above of a fourth configuration of the work station of FIG. 2;

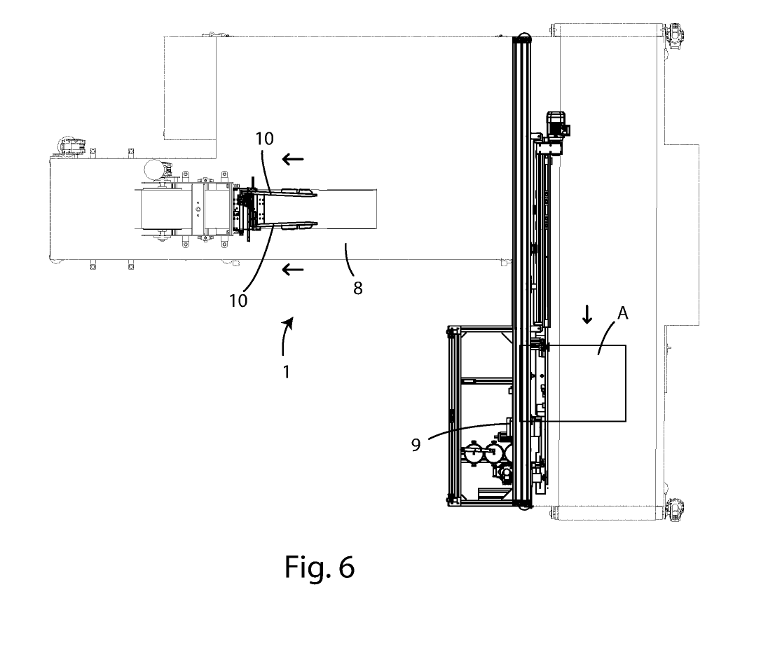

FIG. 6 shows a schematic view from above of a fifth configuration of the work station of FIG. 2;

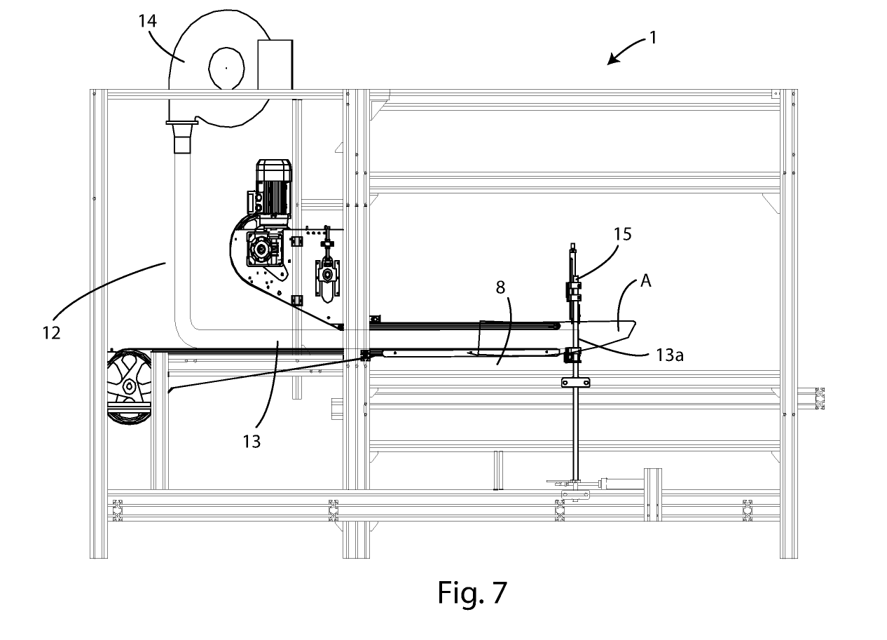

FIG. 7 shows a schematic side view of the work station of FIG. 2 in the first configuration;

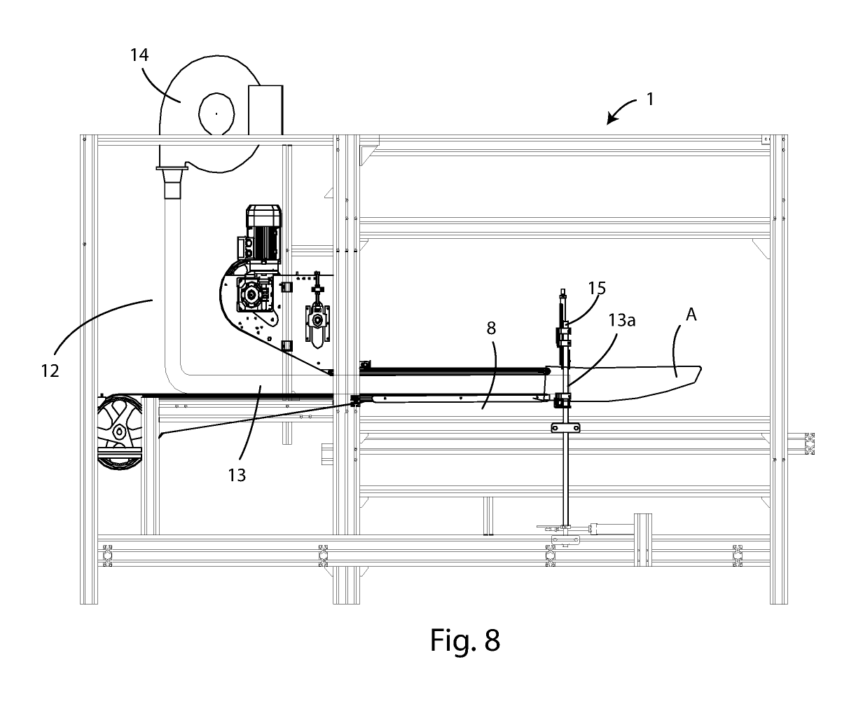

FIG. 8 shows a schematic side view of the work station of FIG. 2 in the second configuration;

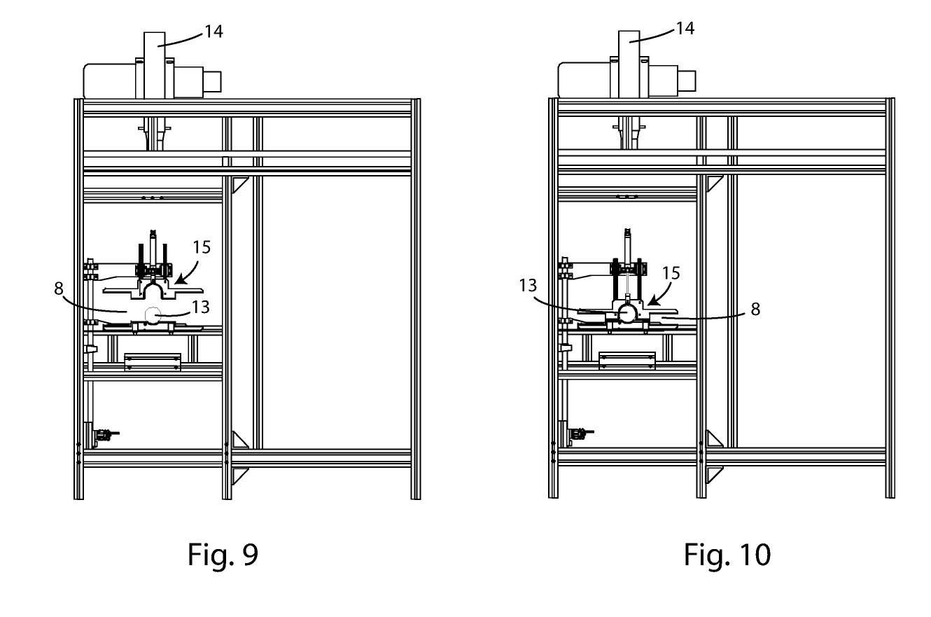

FIG. 9 shows a schematic front view of the work station of FIG. 2 in the first configuration;

FIG. 10 shows a schematic front view of the work station of FIG. 2 in the second configuration;

FIG. 11 shows a schematic view from above of a portion of the work station of FIG. 2 during tensioning of the cover;

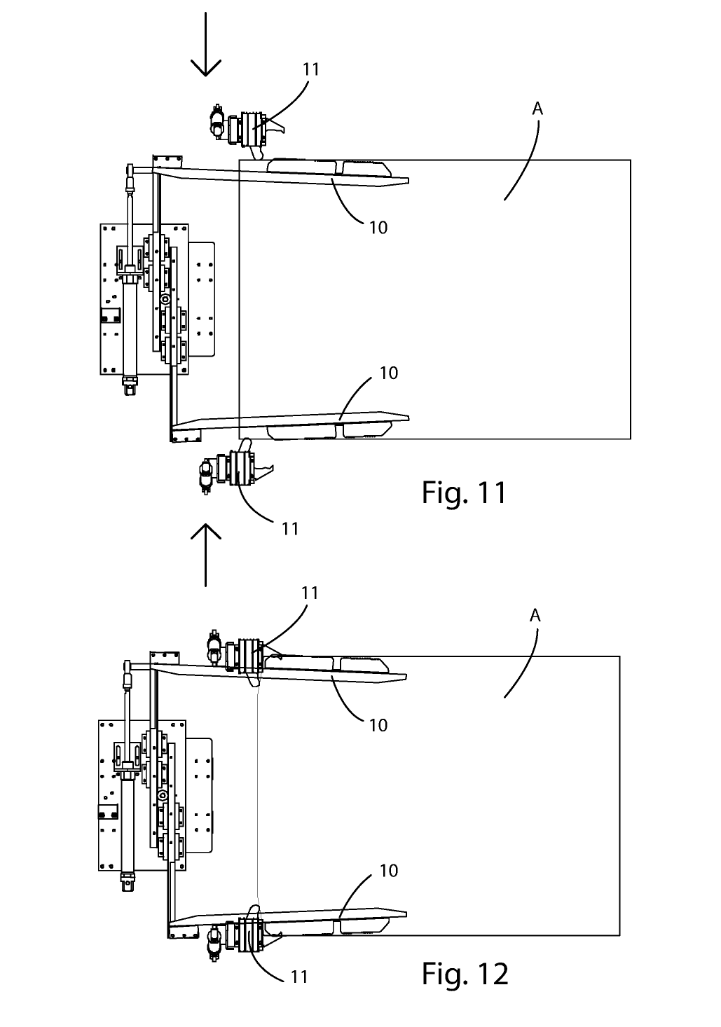

FIG. 12 shows a schematic view from above of a portion of the work station of FIG. 2 during alignment of the grippers;

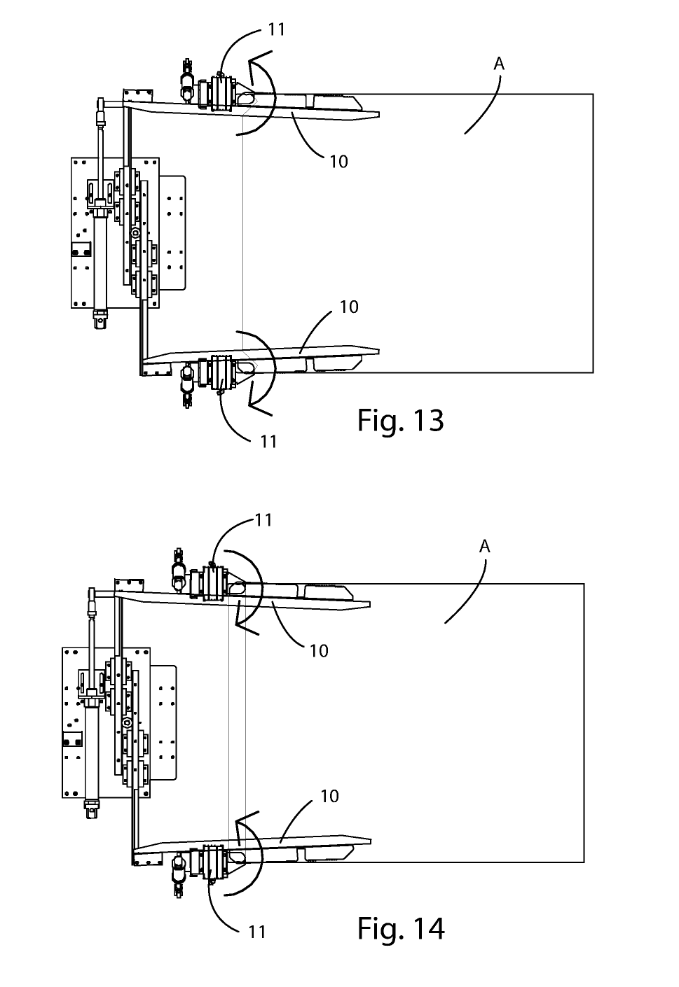

FIG. 13 shows a schematic view from above of a portion of the work station of FIG. 2 during clamping of the grippers;

FIG. 14 shows a schematic view from above of a portion of the work station of FIG. 2 during creation of the turn-up in the cover;

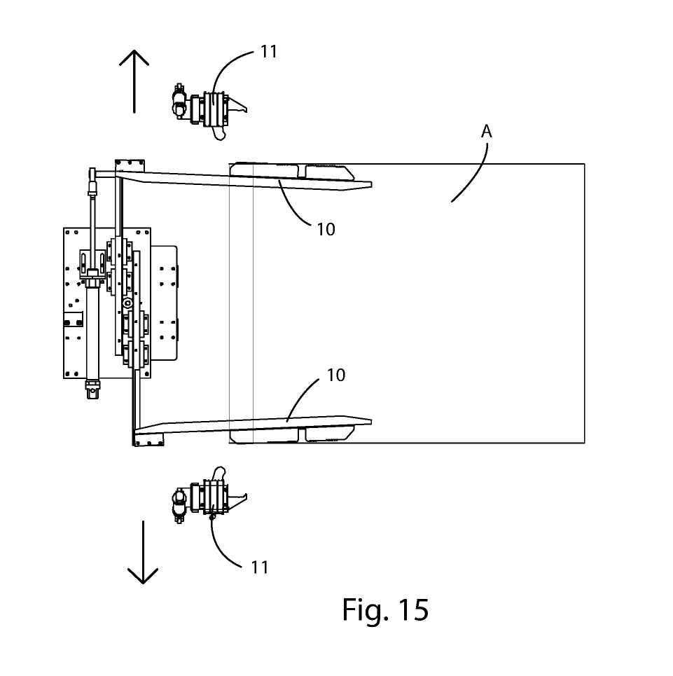

FIG. 15 shows a schematic view from above of a portion of the work station of FIG. 2 during release of the cover turned up.

Numeral 1 in the above-mentioned drawings indicates in its entirety a work station of a system 2 for packaging pillows or cushions.

The system 2 is designed to perform a series of consecutive operations which allow, starting from the raw material, the production of a pillow or cushion and its placing inside a respective packaging suitable for its transport and marketing.

The system 2 comprises, in addition to the work station 1, a labelling machine 3, a device 4 for gripping and shaking the pillow formed (necessary in order to render uniform the distribution of the padding raw material inside the cover A) and a bagging machine 5 for packaging the pillow produced previously.

The work station 1 comprises, in accordance with the provisions also of traditional type work stations, a magazine 6 for stacked covers, a unit 7 for transferring one single cover A at a time on an operating line 8 and a sewing machine 9.

More specifically, the work station 1 according to the invention comprises at least two tensioning lines 10, which are slidable parallel to the movement of the operating line 8 for the entry of their free ends inside the cover A.

The arms 10 can therefore advance along the line 8 until their ends are at least partly inserted inside the cover A: after this configuration of at least partial insertion of the arms 10 in the cover A has been reached it is necessary to use the second possibility of movement of the arms 10.

The arms 10 are in fact also translatable transversely to the movement of the operating line 8, for keeping the cover A in an open configuration: when the arms 10 are partly inserted in the cover A their mutual moving away will determine the contact on the inner walls of the cover A, forcing it to open.

Obviously, the thickness of the end portions of the arms 10 will guarantee that the height of the opening defined by them is suitable for the easy insertion of the padding material.

The work station 1 according to the invention also comprises at least one rotatable gripper 11, for clamping the end flap of the cover (A) and its folding on the cover A, defining an end turn-up.

Basically, the gripper 11 is able to grasp the end flap of the cover A and, being able to rotate with respect to a predetermined axis, can fold the flap on the walls of the cover A (kept open by the arms 10) generating a sort of end hem on the cover A.

It should be noted that, according to the invention, the work station 1 also comprises an apparatus 12 for inserting padding inside the cover A.

With particular reference to an embodiment with clearly interesting application opportunities, there are at least two rotatable grippers 11, each positioned at a respective tensioning arm 10.

In this way, each gripper 11 may act on the end flap of fabric of the cover A which is kept in the correct position by the arm 10, guaranteeing that the turn-up created by the gripper 11 is precise and correctly shaped.

In order to allow an optimum operation of the work station 1, the rotatable gripper 11 will be positioned on a carriage, which will be movable along the direction for moving towards-away from a corresponding tensioning arm 10.

This configuration guarantees that the gripper 11 reaches the arm 10 after this has already engaged in the cover A and aligns with the arm 10 and the cover A suitably opened.

More specifically, it is worth noting that a least a portion of the grippers 11, which is provided with respective jaws, will be pivoted relative to the carriage (the pivoting is performed relative to the predetermined axis of rotation) for turning up the end flap of the cover A: the end flap will in fact be clamped between the jaws and may be easily folded inside the cover A.

It should be noted that, with particular reference to an embodiment of undoubted practical interest, the apparatus 12 for inserting padding inside the cover A will efficiently comprise a magazine for padding raw material having an outfeed intercepted by a conduit 13 having the front end 13a facing and proximal to the inner cavity of the cover A, opened by the arms 10.

The conduit 13 is also connected, upstream, to a forced ventilation unit 14 for creating a flow of air along the conduit 13, directed towards its front end 13a.

The flow of air, generated by the forced ventilation unit 14, will be suitable for drawing the raw material forming the padding into the inner cavity of the cover A filling it according to a pre-set standard.

The invention also comprises the adoption of a scarfing device 15 suitable for blocking the cover A on the front end 13a of the conduit 13 in order to prevent the accidental escape of part of the raw material. The scarfing device 15 comprises a pair of shaped bands which can be moved towards each other (until almost mutual contact) with the interposing of the cover A and the front end 13a of the conduit 13: in this way, when the bands are positioned at the minimum mutual distance, the cover A will be clamped on the front end 13a and the flow of air will drag the padding raw material inside it; there will be no accidental escape of raw material as the distance between the bands will be a minimum and the flaps of the cover A will be substantially touching, preventing the passage of material. It should be noted that, as the cover A will be generally made of fabric, the air conveyed may escape though the fabric itself, thereby avoiding damage due to any internal over-pressure.

With particular reference to the embodiment described above, it should be noted that the padding raw material comprises small separate components made of soft material, of the type preferably selected between feathers, granules of expanded material, foam rubber elements, latex elements, polymeric foam elements, wool, natural fibres, synthetic fibres and the like.

The possibility is not excluded of using monolithic padding (for example, blocks of expanded polymeric material or latex blocks or blocks of natural or polymeric foam); in that case, it will be necessary to provide the conduit 13, the unit 4 and the device 15.

In effect, it will be sufficient to provide a pusher and, if necessary, devices for compressing the block which reduce its dimensions to facilitate the entry in the cover A (which is in turn kept open by the arms 10).

It should be noted that, according to a possible embodiment designed for a very high production (high productivity), the sewing machine 9 is of the so-called “cut and sew” type for “overlock” type sewing.

This type of sewing is characterised by the high degree of simplicity and speed of use and is therefore particularly easy to insert in an automatic production process. For this reason, the sewing performed with “cut and sew” machines does not require skilled workers (if used manually).

However, the sewing machines of the “cut and sew” type use three or four threads for sewing, so a machine stoppage is more likely for the replacement of one of the reels of thread and the formation of incomplete sewing is also more frequent (due to the finishing of one of the reels of thread). Moreover, a “cut and sew” machine cuts the cover A creating waste material. The finished product (pillow or cushion) made with this operating method is considered by the market to be of a lower quality and for this reason this type of sewing is not used for furnishing pillows. More specifically, only 30% of the padding market uses this type of sewing for the closing.

According to a further embodiment, designed for the production of pillows with high quality standards, the sewing machine 9 may, on the other hand, be of the linear type for “lockstitch” type sewing.

This method of sewing is much more advantageous for the manufacturer because it uses a single thread (minimising the number of machine stoppages due to finishing of the thread on the reel and reducing the number of unfinished products due to the above-mentioned finishing of the thread in the reel), and it does not create waste material (it does not cut the cover A during the sewing). Moreover, the product closed with this type of sewing is considered by the market to be of a higher quality; in fact, this particular sewing is also used on furnishing pillows and approximately 70% of the padding market uses this type of sewing for the closing.

Skilled workers are normally required to form this linear sewing, but in this case, thanks to the station 1 according to the invention, it is possible to perform linear sewing in a fully automated manner.

It should be noted that linear sewing is slower than overlock type sewing (that is, formed with a “cut and sew” machine) and, therefore, the system 2 provided with a machine for this type of sewing will have a lower productivity than that of a system equipped with a “cut and sew” machine.

The possibility of fully automating all the steps of a linear sewing process therefore make it unnecessary to adopt a sewing machine of the “cut and sew” type in the station 1 according to the invention (even if this possibility is not excluded a priori): in fact, it would be possible to manage linear sewing in a completely automatic manner, minimising the time necessary for the various steps.

Consequently, the station 1 will be suitable for producing good quality pillows, designed for the furnishing sector, with low costs (the presence of operators is not necessary) and high productivity (the downtimes due to the intervention of the operator are eliminated or, even, masked, by simultaneously actuating two different steps).

The inner turn-up of the cover A is formed automatically after filling the cover A and before sewing.

By analysing the production process in sequence it is seen that: the cover A is automatically positioned on the line 8 and retained by the tensioning arms 10.

The arms 10 carry the cover A suitably filled by the apparatus 12 for inserting a padding towards the sewing machine 9, keeping the flap open in the correct position, ready for the inner turn-up. The turning up is performed by means of two rotatable grippers 11 suitably shaped: the jaws of the grippers 11 move simultaneously horizontally and vertically to approach the open flap and subject it to a further tensioning. The closing of the jaws of the grippers 11 on the end flap of the cover A allows the clamping and a successive rotation of the jaws forming the turn-up towards the inside. At this point, the tensioning arms 10 close and come out from the cover A leaving it only clamped by the grippers 11.

In accordance with the known solutions of the same Applicant, there will be a lowering of suitable pistons for blocking the cover A on the sewing bench.

The cover A (filled and blocked in this way) may be easily transferred to the linear sewing machine 9 in full compliance with known embodiments by the same Applicant: it is then possible to proceed to the sewing of the cover A.

As mentioned above, in order to obtain a linear sewing (lockstitch) the open flap of the cover A must be turned up and the sewing machine must be positioned on a mobile unit which is able to compensate for all the positioning errors due to the movement of the padded cover A during the production process.

A control and management system must therefore detect the position of the edge to be sewn with respect to a control point on the sewing bench and adapt the position of the sewing machine on the basis of parameters pre-set by an operator.

Advantageously, this invention overcomes the above-mentioned problems, providing a work station 1 of a system 2 for packaging pillows which is fully automated. As mentioned above, once the station 1 has been started, interventions by the operator are no longer necessary.

Conveniently, the work station 1 is able to package high quality pillows: in fact, the formation of linear sewing (lockstitch) allows the quality requirements typical of the furnishing sector and/or of very demanding users to be satisfied.

The work station 1 effectively allows a closure sewing without waste and having upturned edges.

Positively, the work station 1 of a system 2 for packaging pillows proposed here can be actuated in a substantially simple manner and with substantially low costs: these features constitute a valid index for assuming a safe application of the station 1 according to the invention.

The invention as it is conceived is susceptible to numerous modifications and variants, all falling within the scope of protection of the inventive concept; further, all the details can be replaced by other technically equivalent elements.

In the embodiments illustrated, individual features, described in relation to specific examples, can in reality be interchanged with other different features, existing in other example embodiments.

In practice, the materials used, as well as the dimensions, can be varied according to the requirements and the state of the art.

1. Work station of a system for packaging pillows of the type comprising a magazine for stacked covers, a unit for transferring one single cover at a time on an operating line and a sewing machine, characterised in that it comprises at least two tensioning lines, slidable parallel to the movement of said operating line for the entry of their free ends inside said cover and translatable transversely to the movement of said operating line for keeping the cover in the open configuration, at least one rotatable gripper, rotatable with respect to said operating line, said rotatable gripper being arranged for clamping the end flap of said cover and its folding on the cover defining an end turn-up, and at least one apparatus for inserting a padding inside said cover.

2. Work station according to claim 1, characterised in that there are at least two said rotatable grippers, each positioned at a respective tensioning arm.

3. Work station according to claim 1, characterised in that said rotatable gripper is positioned on a carriage, movable along the direction of moving away from-towards a corresponding tensioning arm, at least a portion of said gripper, comprising respective jaws, being pivoted relative to said carriage for turning up the end flap of said cover, clamped between said jaws, inside the cover.

4. Work station according to claim 1, characterised in that said apparatus for inserting padding inside said cover comprises a magazine for padding raw material having an outfeed intercepted by a conduit having the front end facing and proximal to the inner cavity of said cover, opened by said arms, and connected, upstream, to a forced ventilation unit for creating a flow of air along the conduit, directed towards its front end.

5. Work station according to claim 4, characterised in that said padding raw material comprises small separate components made of soft material, of the type preferably selected between feathers, granules of expanded material, foam rubber elements, latex elements, polymeric foam elements, wool, natural fibres, synthetic fibres and the like.

6. Work station according to claim 1, characterised in that said sewing machine is of the so-called “cut and sew” type for “overlock” type sewing.

7. Work station according to claim 1, characterised in that said sewing machine is of the linear type for “lockstitch” type sewing.
